(19) United States
(12) Patent Application Publication
(10) Pub. No.: US 2026/0125111 A1
(43) Pub. Date: May 7, 2026

(54) SYSTEM AND METHOD TO ADJUST STEERING RATIO WHILE TRAILERING USING A STEER-BY-WIRE SYSTEM

(71) Applicant: GM Global Technology Operations LLC, Detroit, MI (US)

(72) Inventors: Amin Habibnejad Korayem, Markham (CA); Avesta Goodarzi, Whitby (CA); Mahdokht Ezati, Pickering (CA); Seyedeh Asal Nahidi, North York (CA); Hojjat Izadi, Richmond Hill (CA); SeyedAlireza Kasaiezadeh Mahabadi, Novi, MI (US)

(21) Appl. No.: 18/936,307

(22) Filed: Nov. 4, 2024

(51) Int. Cl. B62D 13/00; B62D 6/00

(52) U.S. Cl. CPC B62D 13/00; B62D 6/001; B62D 6/002

(57) ABSTRACT

A vehicle employs a method of towing a trailer. A speedometer measures a current velocity of the vehicle. A hitch length sensor obtains a current trailer length of the trailer. A steering angle sensor measures a steering wheel angle of a steering wheel of the vehicle. A processor determines a velocity difference between the current velocity of the vehicle and a nominal velocity of the vehicle, determines a length difference between the current trailer length and a nominal trailer length, calculates a dynamic steering ratio based on the length difference and the velocity difference, determines a road wheel angle for the vehicle from the steering wheel angle and the dynamic steering ratio, and controls a road wheel actuator to obtain the road wheel angle to steer the vehicle.

The subject disclosure relates to towing a trailer behind a vehicle and, in particular, to a system and method for dynamically adjusting a steering ratio of a steer-by-wire system of the vehicle to provide a same hitch angle for a same steering angle across different trailer lengths and towing velocities.

Steering while towing a trailer can be a tricky maneuver, especially when the driver is towing trailers of varying lengths as part of a daily routine. In turns, a hitch angle between the vehicle and the trailer can vary based on the dynamic parameters of trailer motion, which is influenced by factors such as trailer length and vehicle velocity. The driver needs to adjust his driving behavior to accommodate changes in these dynamic parameters. This requires a high level of skill on the part of the driver. Accordingly, it is desirable to provide a system and method for reducing or eliminating differences in trailer behavior as changes occur in these dynamic parameters.

### SUMMARY

In one exemplary embodiment, a method of towing a trailer behind a vehicle is disclosed. A current velocity of the vehicle is measured. A current trailer length of the trailer is measured. A velocity difference is determined between the current velocity of the vehicle and a nominal velocity of the vehicle. A length difference is determined between the current trailer length and a nominal trailer length. A dynamic steering ratio is calculated based on the length difference and the velocity difference. A steering wheel angle of the vehicle is measured. A road wheel angle is determined for the vehicle from the steering wheel angle and the dynamic steering ratio. A road wheel actuator is controlled to obtain the road wheel angle to steer the vehicle.

In addition to one or more of the features described herein, the method further includes calculating the dynamic steering ratio based on a wheel base of the vehicle and a trailer distance between a hitch point and a rear wheel axle of the trailer.

In addition to one or more of the features described herein, the method further includes determining whether the trailer is connected to the vehicle and performing one of calculating the road wheel angle using the dynamic steering ratio when the trailer is connected and calculating the road wheel angle using a static steering ratio when the trailer is not connected.

In addition to one or more of the features described herein, the method further includes steering the vehicle using the static steering ratio when at least one of the vehicle is not moving in reverse, a velocity of the vehicle is outside of a selected velocity range, and a sway of the vehicle is outside of a selected stability range.

In addition to one or more of the features described herein, the method further includes determining an equation of motion for a hitch angle based on the nominal trailer length and the nominal velocity.

In addition to one or more of the features described herein, the method further includes using the dynamic steering ratio to obtain a selected hitch angle for a selected steering wheel angle for a first trailer having a first length and to obtain the selected hitch angle for the selected steering wheel angle for a second trailer having a second length.

In addition to one or more of the features described herein, the method further includes using the dynamic steering ratio to obtain a selected hitch angle for a selected steering wheel angle when the vehicle is moving at a first velocity to obtain the selected hitch angle for the selected steering wheel angle when the vehicle is moving at a second velocity.

In another exemplary embodiment, a system for towing a trailer behind a vehicle is disclosed. The processor is configured to obtain a current velocity of the vehicle, obtain a current trailer length of the trailer, determine a velocity difference between the current velocity of the vehicle and a nominal velocity of the vehicle, determine a length difference between the current trailer length and a nominal trailer length, calculate a dynamic steering ratio based on the length difference and the velocity difference, obtain a steering wheel angle of the vehicle, determine a road wheel angle for the vehicle from the steering wheel angle and the dynamic steering ratio, and control a road wheel actuator to obtain the road wheel angle to steer the vehicle.

In addition to one or more of the features described herein, the processor is further configured to calculate the dynamic steering ratio based on a wheel base of the vehicle and a trailer distance between a hitch point and a rear wheel axle of the trailer.

In addition to one or more of the features described herein, the processor is further configured to determine whether the trailer is connected to the vehicle and perform one of calculating the road wheel angle using the dynamic steering ratio when the trailer is connected and calculating the road wheel angle using a static steering ratio when the trailer is not connected.

In addition to one or more of the features described herein, the processor is further configured to steer the vehicle using the static steering ratio when at least one of the vehicle is not moving in reverse, a velocity of the vehicle is outside of a selected velocity range, and a sway of the vehicle is outside of a selected stability range.

In addition to one or more of the features described herein, the processor is further configured to determine an equation of motion for a hitch angle based on the nominal trailer length and the nominal velocity.

In addition to one or more of the features described herein, the processor is further configured to use the dynamic steering ratio to obtain a selected hitch angle for a selected steering wheel angle for a first trailer having a first length and to obtain the selected hitch angle for the selected steering wheel angle for a second trailer having a second length.

In addition to one or more of the features described herein, wherein the processor is further configured to use the dynamic steering ratio to obtain a selected hitch angle for a selected steering wheel angle when the vehicle is moving at a first velocity to obtain the selected hitch angle for the selected steering wheel angle when the vehicle is moving at a second velocity.

In yet another exemplary embodiment, a vehicle for towing a trailer is disclosed. The vehicle includes a speedometer for measuring a current velocity of the vehicle, a hitch length sensor for obtaining a current trailer length of the trailer, a steering angle sensor for measuring a steering wheel angle of a steering wheel of the vehicle, and a processor. The processor is configured to determine a velocity difference between the current velocity of the vehicle and a nominal velocity of the vehicle, determine a length difference between the current trailer length and a nominal trailer length, calculate a dynamic steering ratio based on the length difference and the velocity difference, determine a road wheel angle for the vehicle from the steering wheel angle and the dynamic steering ratio, and control a road wheel actuator to obtain the road wheel angle to steer the vehicle.

In addition to one or more of the features described herein, the processor is further configured to calculate the dynamic steering ratio based on a wheel base of the vehicle and a trailer distance between a hitch point and a rear wheel axle of the trailer.

In addition to one or more of the features described herein, the processor is further configured to determine whether the trailer is connected to the vehicle and perform one of calculating the road wheel angle using the dynamic steering ratio when the trailer is connected and calculating the road wheel angle using a static steering ratio when the trailer is not connected.

In addition to one or more of the features described herein, the processor is further configured to steer the vehicle using the static steering ratio when at least one of the vehicle is not moving in reverse, a velocity of the vehicle is outside of a selected velocity range, and a sway of the vehicle is outside of a selected stability range.

In addition to one or more of the features described herein, the processor is further configured to determine an equation of motion for a hitch angle based on the nominal trailer length and the nominal velocity.

In addition to one or more of the features described herein, the processor is further configured to perform at least one of using the dynamic steering ratio to obtain a selected hitch angle for a selected steering wheel angle for a first trailer having a first length and to obtain the selected hitch angle for the selected steering wheel angle for a second trailer having a second length and using the dynamic steering ratio to obtain a selected hitch angle for a selected steering wheel angle when the vehicle is moving at a first velocity to obtain the selected hitch angle for the selected steering wheel angle when the vehicle is moving at a second velocity.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a side view of a vehicle towing a trailer in accordance with an exemplary embodiment;

FIG. 2 shows a top schematic view of the vehicle and the trailer of FIG. 1;

FIG. 3 is an architecture of a software system for steering a vehicle using different steering ratios;

FIG. 4 shows an enablement flowchart for a method performed at the controller to determine whether a dynamic steering ratio is to be calculated and used at the steer-by-wire module;

FIG. 5 shows a graph of various angles over time for a vehicle towing a trailer using a constant steering ratio; and

FIG. 6 shows a graph of various angles over time for a vehicle towing a trailer using an adjustable steering ratio.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

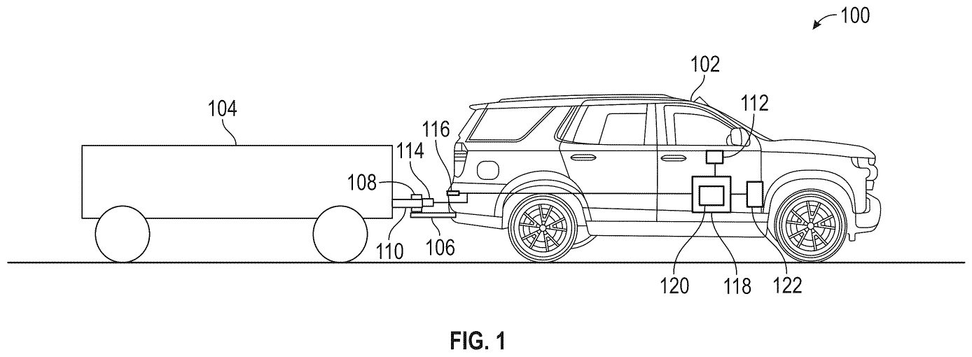

In accordance with an exemplary embodiment, FIG. 1 shows a side view 100 of a vehicle 102 towing a trailer 104. The vehicle 102 has a hitch 106 (or hitching device) that extends from a rear bumper of the vehicle along a longitudinal axis of the vehicle. The hitch 106 generally has a ball or post 108. The trailer 104 includes a tongue 110 at its front end that hooks onto the post 108, thereby coupling the trailer to the vehicle 102. The tongue 110 is coupled to the hitch 106 to allow rotational flexibility between the trailer 104 and the vehicle 102.

Various sensors on the vehicle 102 obtain measurements suitable for operating the vehicle to tow the trailer. The sensors include a steering angle sensor 112, a hitch connection sensor 114 and a hitch length sensor 116. The steering angle sensor 112 measures a steering wheel angle of a steering wheel. The hitch connection sensor 114 is located at hitch 106 and detects whether the trailer is hitched to the vehicle or not. The hitch length sensor 116 is located at the rear bumper of the vehicle and detects a distance between the rear bumper of the vehicle 102 and a front end of the trailer 104. The hitch length sensor 116 can be an ultrasonic sensor. In an embodiment, the hitch length sensor 116 transmits an acoustic or electromagnetic signal, receives a reflection of the signal, measures a time-of-flight of the signal and calculates the hitch distance based on the time-of-flight.

Data from the sensors are provided to a steer-by-wire system 118. The steer-by-wire system 118 includes a controller 120 for performing a steer-by-wire using the methods disclosed herein. The controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 120 may include a non-transitory computer-readable medium that stores instructions which, when processed by one or more processors of the controller 120, implements a method of determining a dynamic steering ratio between the steering wheel angle and the road wheel angle and steering the vehicle using the steering ratio, according to one or more embodiments detailed herein.

A steering ratio is a ratio between the steering wheel angle at the steering wheel and the road wheel angle applied to the wheels. The steering ratio can be a constant value or can be software configurable, as discussed herein. In various embodiments, the steer-by-wire system 118 calculates a road wheel angle (RWA) that corresponds to the steering wheel angle (SWA) using either a static steering ratio or a dynamic steering ratio and sends a steering command to a road wheel actuator 122 which generates the road wheel angle at wheels of the vehicle.

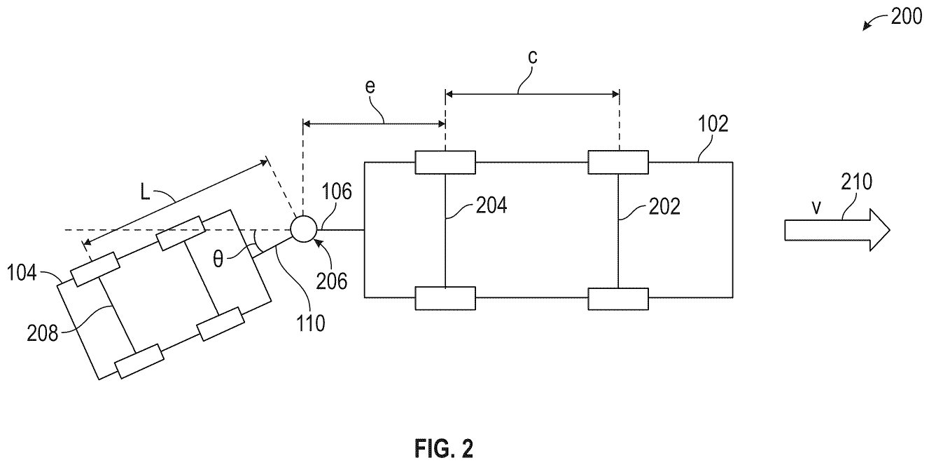

FIG. 2 shows a top schematic view 200 of the vehicle 102 and the trailer 104 of FIG. 1. The top view 200 shows various parameters relevant to towing of the trailer 104. The vehicle 102 shows a front axle 202 connecting front tires and a rear axle 204 connecting rear tires. Parameter c is the length of the wheel base of the vehicle (i.e., the longitudinal distance between the front axle 202 and the rear axle 204). Parameter e is a hitch distance (i.e., longitudinal distance from rear axle 204 to a hitch point 206 at which the post 108 connects to the tongue 110). Parameter L is the length of the trailer 104 (i.e., longitudinal distance from a rear axle 208 of the trailer 108 to the hitch point 206).

During a turn, the vehicle 102 and the trailer 104 can make a non-zero angle with each other, as shown by hitch angle θ between the tongue 110 and the hitch 106 at the hitch point 206. The hitch angle θ is measured between the longitudinal axis of the vehicle 102 and the longitudinal axis of the trailer 104. Arrow 210 indicates forward longitudinal velocity v of the vehicle 102.

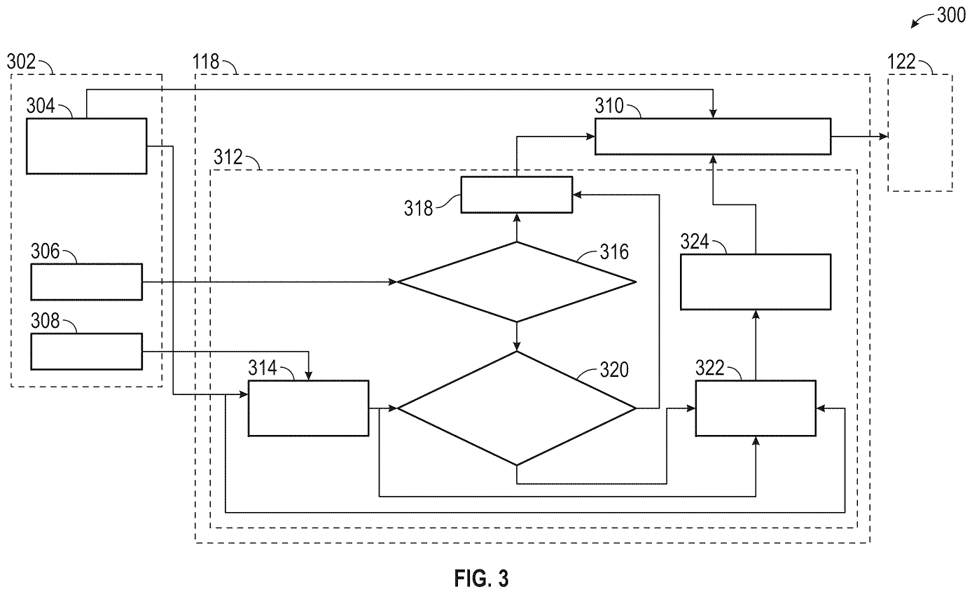

FIG. 3 is an architecture 300 of a software system for steering a vehicle using different steering ratios. The architecture 300 includes vehicle sensors 302, the steer-by-wire system 118, and the road wheel actuator 122. The vehicle sensors 302 provide various data. The data includes a steering wheel angle 304 (from the steering angle sensor 112), a trailer hitch bit 306 (from the hitch connection sensor 114) indicating whether a trailer is hitched to the vehicle, and a hitch length 308 (from the hitch length sensor 116).

The steer-by-wire system 118 includes a steer-by-wire module 310 and a supervisory control module 312 that run at a processor of the controller 120. The supervisory control module 312 performs calculations to control an operation at the steer-by-wire module 310 to tow the trailer 104 using either a static steering ratio between steering angle and road wheel angle or a dynamic steering ratio between steering angle and road wheel angle.

In box 314, a hitch angle θ is calculated based on the steering wheel angle 304 and the hitch length 308. The hitch angle θ is provided to an enablement module in box 320 and to a steering ratio calculator in box 322.

Turning now to box 316, a detector algorithm determines whether a trailer is detected as attached to the vehicle, based on the trailer hitch bit 306. If no trailer is detected, the method proceeds to the box 318. In box 318, a static steering ratio K is selected. The static steering ratio K can be a standard steering ratio that is set by the manufacturer. The standard steering ratio K is provided to the steer-by-wire module 310. The steer-by-wire module 310 sends a road wheel angle command to the road wheel actuator 122 to generate the road wheel angle using the steering wheel angle 304 and the static steering ratio K.

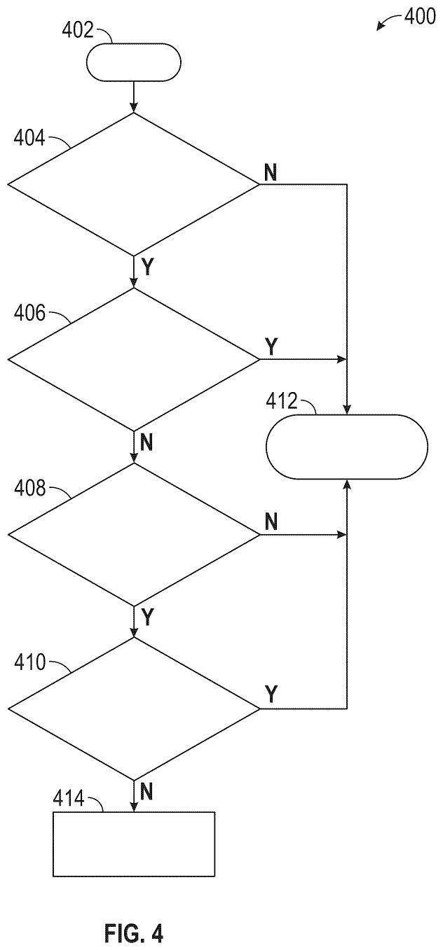

Returning to box 316, if a trailer is detected, the method proceeds to box 320. In box 320, enablement tests are run (as shown in FIG. 4) to determine whether conditions are suitable for steering ratio adjustment. If the enablement tests are passed, the method proceeds to box 322. Otherwise, the method proceeds to box 318 to allow the steer-by-wire module 310 to operate using the static steering ratio.

Turning now to box 322, a dynamic steering ratio K̅ is calculated based on various towing parameters. The dynamic steering ratio K̅ is a steering ratio that adjusts so as to provide a same steering wheel for a trailer configuration, such as any trailer length and/or any towing velocity. In box 324, the dynamic steering ratio K̅ is provided to the steer-by-wire module 310. The steer-by-wire module 310 generates a road wheel angle command using the steering wheel angle 304 and the dynamic steering ratio K̅. The steer-by-wire module 310 then provides the road wheel angle command to the road wheel actuator 122 based on the steering angle and the dynamic steering ratio.

FIG. 4 shows an enablement flowchart 400 for a method performed at the controller (box 318) to determine whether a dynamic steering ratio is to be calculated and used at the steer-by-wire system 118. The method starts at box 402. In box 404, the trailer connection is checked to determine whether a trailer 104 is connected. The trailer connection can be confirmed by one or more of detecting a signal from a trailer brake or detecting a signal indicates a trailer connection status. If a trailer is not connected, the method proceeds to box 412. At box 412, the method exits to perform steering at the steer-by-wire module 310 using the constant steering ratio K. Returning to box 404, if a trailer is connected, the method proceeds to box 406.

In box 406, the driving gears of the vehicle are checked to determine if the vehicle is driving in reverse. The reverse gear can be determined by a signal indicating the status of the transmission or by determining that the vehicle velocity is less than a suitable forward velocity threshold. If the vehicle is in reverse, the method proceeds to box 412. Otherwise (i.e., the vehicle is moving forward) the method proceeds to box 408.

In box 408, the vehicle velocity is measured. If the vehicle is outside of a selected velocity range, the method proceeds to box 412. The selected velocity range can be a calibrated range. Otherwise, (i.e., the vehicle is inside the selected velocity range), the method proceeds to box 410.

In box 410, a sway of the trailer is measured. The sway is a rapid lateral oscillation of the trailer that occurs under certain conditions or at certain velocities. If the sway of the trailer is outside of a selected stability range, the method proceeds to box 412. The stability range can be a calibrated range. Otherwise, (i.e., the sway is within the selected stability range), the method proceeds to box 412. In box 412, the method proceeds to calculate a dynamic steering ratio for use by the steer-by-wire module 310.

The dynamic steering ratio K is determined using various parameters, such as the hitch angle, a length of the trailer, a velocity of the vehicle, a wheel base on the vehicle, a trailer distance, the steering wheel angle and the steering ratio. An equation of motion for the hitch angle for a vehicle traveling at given velocity and a trailer having selected trailer length is shown in Eq. (1):

$$\dot{θ} = \frac{v}{L} θ - \frac{v}{c} tan K {δ}_{h} ( 1 + \frac{e}{L} cos K {δ}_{h} ) \qquad Eq . ( 1 )$$

where v is the velocity of the vehicle, L is the trailer length, c is the length of the wheel base of the vehicle, e is the hitch length measured from a rear wheel axle to the hitch point, K is the steering ratio, and δₕ is the steering wheel angle (or hand wheel angle). A linearized form of Eq. (1) for small angles is shown in Eq. (2):

$$\dot{θ} = \frac{v}{L} θ - ( \frac{v}{c} + \frac{v e}{c L} ) K {δ}_{h} \qquad Eq . ( 2 )$$

Eq. (2) can be solved for a standard trailer of nominal trailer length Lₙ being towed at a standard velocity or nominal velocity vₙ. When nominal values are replaced in Eq. (2), the equation of motion is as shown in Eq. (3):

$$\dot{θ} = \frac{{v}_{n}}{{L}_{n}} θ - ( \frac{{v}_{n}}{c} + \frac{{v}_{n} e}{c {L}_{n}} ) K {δ}_{h} \qquad Eq . ( 3 )$$

The nominal solution for the equation of motion can be used as a starting point for trailers having differing trailer lengths and being towed at different velocities. The current velocity v̅ of the vehicle can be written as shown in Eq. (4):

$$\overline{v} = {v}_{n} + Δ v \qquad Eq . ( 4 )$$

where αv is the velocity difference between the current velocity and the nominal velocity vₙ. Similarly, a current trailer length L̅ of the trailer (i.e., actual trailer length) can be written as shown in Eq. (5):

$$\overline{L} = {L}_{n} + Δ L \qquad Eq . ( 5 )$$

where ΔL is the length difference between the current trailer length and the nominal trailer length Lₙ.

From Eq. (2), an equation of motion for the current trailer length L̅ and the current velocity v̅ can be written as shown in Eq. (6)

$$\dot{θ} = \frac{( {v}_{n} + Δ v )}{( {L}_{n} + Δ L )} θ - ( \frac{( {v}_{n} + Δ v )}{c} + \frac{( {v}_{n} + Δ v ) e}{c ( {L}_{n} + Δ L )} ) K {δ}_{h} \qquad Eq . ( 6 )$$

A dynamic steering ratio K̅ can be defined with respect to the static steering ratio K, as shown in Eq. (7)

$$\overline{K} = ( \frac{Δ v}{Δ L} - ( \frac{Δ v}{c} + \frac{Δ ve}{c Δ L} ) K \qquad Eq . ( 7 )$$

Using the dynamic steering ratio from Eq. (7), the equation of motion of Eq. (3) can be rewritten as shown in Eq. (8):

$$\dot{θ} = \frac{{v}_{n}}{{L}_{n}} θ - ( \frac{{v}_{n}}{c} + \frac{{v}_{n} e}{c {L}_{n}} ) \overline{K} {δ}_{h} \qquad Eq . ( 8 )$$

Eq. (8) can then be used by the steer-by-wire module 310 to steer the vehicle.

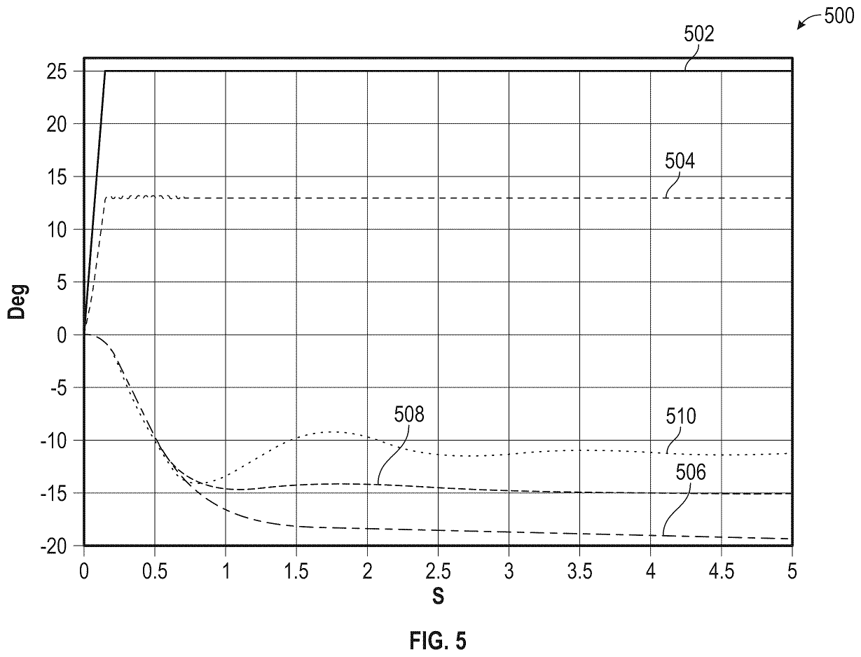

FIG. 5 shows a graph 500 of various angles over time for a vehicle towing a trailer using a constant steering ratio. Time is shown along the abscissa in seconds (s) and angle is shown along the ordinate axis in degrees (deg). A first curve 502 represents a tenth of a steering wheel angle (SWA/10) and a second curve 504 shows a road wheel angle corresponding to the steering wheel angle. The hand wheel angle is turned from zero degrees to 250 degrees in about 0.2 seconds. Since the steering wheel ratio is constant (after about 0.2 seconds), the road wheel angle maintains a constant relation to the hand wheel angle over the time frame shown.

A third curve 506 represents a hitch angle for a vehicle towing a trailer having a trailer length of 3 meters. For the steering wheel angle of 250 degrees, the hitch angle stabilizes at about −18 degrees. A fourth curve 508 represents a hitch angle for a vehicle towing a trailer having a trailer length of 5 meters. For the steering wheel angle of 250 degrees, the hitch angle stabilizes at about −15 degrees. A fifth curve 510 represents a hitch angle for a vehicle towing a trailer having a trailer length of 7 meters. For the steering wheel angle of 250 degrees, the hitch angle stabilizes at about −12 degrees.

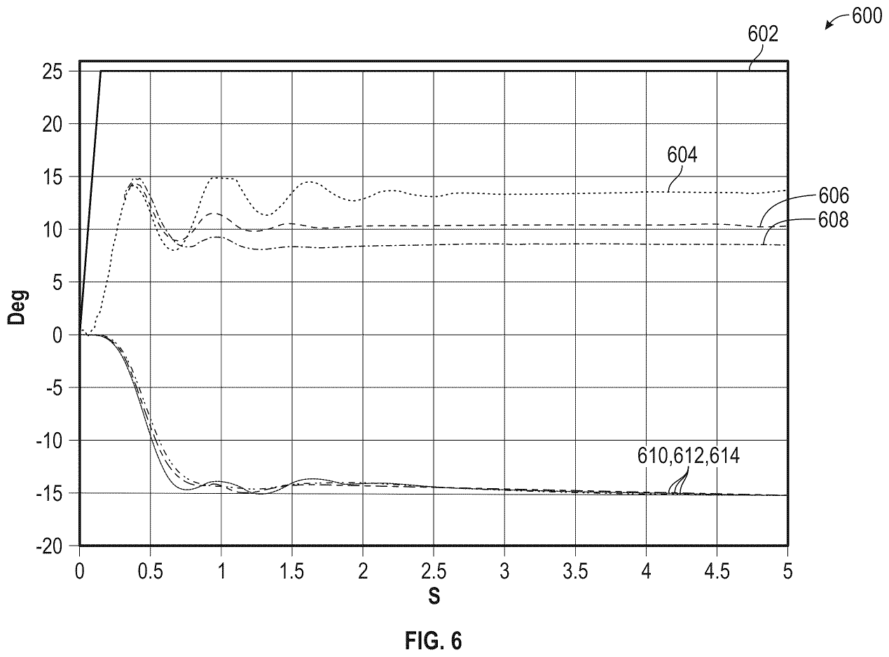

FIG. 6 shows a graph 600 of various angles over time for a vehicle towing a trailer using an adjustable steering ratio. Time is shown along the abscissa in seconds (s) and angle is shown along the ordinate axis in degrees (deg). A first curve 602 represents a tenth of a steering wheel angle (SWA/10). A second curve 604 shows a road wheel angle corresponding to the hand wheel angle for a trailer having length of 3 meters. A third curve 606 shows a road wheel angle corresponding to the hand wheel angle for a trailer having length of 5 meters. A fourth curve 608 shows a road wheel angle corresponding to the hand wheel angle for a trailer having length of 7 meters. Since the steering ratio is adjusted based on trailer length, the road wheel angle is different for each of the second curve 604 (L=3 m), the third curve 606 (L=5 m) and the fourth curve 608 (L=7 m). The speed is assumed constant for this test to better show the results on trailer length changes. However, same result is expected at various speeds.

A fifth curve 610 represents a hitch angle for a trailer length of L=3 m. A sixth curve 612 represents a hitch angle for a trailer length of L=5 m. A seventh curve 614 represents a hitch angle for a trailer length of L=7 m. Due to use of the dynamic steering ratio, the hitch angle for each of the lengths (L=3 m, L=5 m, L=7 m) converge over time to a same value (e.g., about −15 degrees). As a result, fifth curve 610, sixth curve 612 and seventh curve 614 are seen to converge to overlap each other over time.

Thus, the steering angle required by the driver during a turn is the same regardless of the length of the trailer or a velocity of the vehicle. For a first trailer having first length, the driver can rotate the steering wheel by a selected steering wheel angle and obtain a selected hitch angle between the vehicle and the trailer. For a second trailer having a second length, the driver can rotate the steering wheel by the same selected steering wheel angle and obtain the same selected hitch angle. Similarly, when the vehicle is moving at a first velocity, the driver can rotate the steering wheel by a selected steering wheel angle and obtain a selected hitch angle. When the vehicle is moving at a second velocity, the driver can rotate the steering wheel by the same selected steering wheel angle and obtain the same selected hitch angle.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of towing a trailer behind a vehicle, comprising:
measuring a current velocity of the vehicle;
measuring a current trailer length of the trailer;
determining a velocity difference between the current velocity of the vehicle and a nominal velocity of the vehicle;
determining a length difference between the current trailer length and a nominal trailer length;
calculating a dynamic steering ratio based on the length difference and the velocity difference;
measuring a steering wheel angle of the vehicle;
determining a road wheel angle for the vehicle from the steering wheel angle and the dynamic steering ratio; and
controlling a road wheel actuator to obtain the road wheel angle to steer the vehicle.

2. The method of claim 1, further comprising calculating the dynamic steering ratio based on a wheel base of the vehicle and a trailer distance between a hitch point and a rear wheel axle of the trailer.

3. The method of claim 1, further comprising determining whether the trailer is connected to the vehicle and performing one of: (i) calculating the road wheel angle using the dynamic steering ratio when the trailer is connected; and (ii) calculating the road wheel angle using a static steering ratio when the trailer is not connected.

4. The method of claim 3, further comprising steering the vehicle using the static steering ratio when at least one of: (i) the vehicle is not moving in reverse; (ii) a velocity of the vehicle is outside of a selected velocity range; and (iii) a sway of the vehicle is outside of a selected stability range.

5. The method of claim 1, further comprising determining an equation of motion for a hitch angle based on the nominal trailer length and the nominal velocity.

6. The method of claim 1, further comprising using the dynamic steering ratio to obtain a selected hitch angle for a selected steering wheel angle for a first trailer having a first length and to obtain the selected hitch angle for the selected steering wheel angle for a second trailer having a second length.

7. The method of claim 1, further comprising using the dynamic steering ratio to obtain a selected hitch angle for a selected steering wheel angle when the vehicle is moving at a first velocity to obtain the selected hitch angle for the selected steering wheel angle when the vehicle is moving at a second velocity.

8. A system for towing a trailer behind a vehicle, comprising:
a processor configured to:
obtain a current velocity of the vehicle;
obtain a current trailer length of the trailer;
determine a velocity difference between the current velocity of the vehicle and a nominal velocity of the vehicle;
determine a length difference between the current trailer length and a nominal trailer length;
calculate a dynamic steering ratio based on the length difference and the velocity difference;
obtain a steering wheel angle of the vehicle;
determine a road wheel angle for the vehicle from the steering wheel angle and the dynamic steering ratio; and
control a road wheel actuator to obtain the road wheel angle to steer the vehicle.

9. The system of claim 8, wherein the processor is further configured to calculate the dynamic steering ratio based on a wheel base of the vehicle and a trailer distance between a hitch point and a rear wheel axle of the trailer.

10. The system of claim 8, wherein the processor is further configured to determine whether the trailer is connected to the vehicle and perform one of: (i) calculating the road wheel angle using the dynamic steering ratio when the trailer is connected; and (ii) calculating the road wheel angle using a static steering ratio when the trailer is not connected.

11. The system of claim 10, wherein the processor is further configured to steer the vehicle using the static steering ratio when at least one of: (i) the vehicle is not moving in reverse; (ii) a velocity of the vehicle is outside of a selected velocity range; and (iii) a sway of the vehicle is outside of a selected stability range.

12. The system of claim 8, wherein the processor is further configured to determine an equation of motion for a hitch angle based on the nominal trailer length and the nominal velocity.

13. The system of claim 8, wherein the processor is further configured to use the dynamic steering ratio to obtain a selected hitch angle for a selected steering wheel angle for a first trailer having a first length and to obtain the selected hitch angle for the selected steering wheel angle for a second trailer having a second length.

14. The system of claim 8, wherein the processor is further configured to use the dynamic steering ratio to obtain a selected hitch angle for a selected steering wheel angle when the vehicle is moving at a first velocity to obtain the selected hitch angle for the selected steering wheel angle when the vehicle is moving at a second velocity.

15. A vehicle for towing a trailer, comprising:
a speedometer for measuring a current velocity of the vehicle;
a hitch length sensor for obtaining a current trailer length of the trailer;
a steering angle sensor for measuring a steering wheel angle of a steering wheel of the vehicle; and
a processor configured to:
determine a velocity difference between the current velocity of the vehicle and a nominal velocity of the vehicle;
determine a length difference between the current trailer length and a nominal trailer length;
calculate a dynamic steering ratio based on the length difference and the velocity difference;
determine a road wheel angle for the vehicle from the steering wheel angle and the dynamic steering ratio; and
control a road wheel actuator to obtain the road wheel angle to steer the vehicle.

16. The vehicle of claim 15, wherein the processor is further configured to calculate the dynamic steering ratio based on a wheel base of the vehicle and a trailer distance between a hitch point and a rear wheel axle of the trailer.

17. The vehicle of claim 15, wherein the processor is further configured to determine whether the trailer is connected to the vehicle and perform one of: (i) calculating the road wheel angle using the dynamic steering ratio when the trailer is connected; and (ii) calculating the road wheel angle using a static steering ratio when the trailer is not connected.

18. The vehicle of claim 17, wherein the processor is further configured to steer the vehicle using the static steering ratio when at least one of: (i) the vehicle is not moving in reverse; (ii) a velocity of the vehicle is outside of a selected velocity range; and (iii) a sway of the vehicle is outside of a selected stability range.

19. The vehicle of claim 15, wherein the processor is further configured to determine an equation of motion for a hitch angle based on the nominal trailer length and the nominal velocity.

20. The vehicle of claim 15, wherein the processor is further configured to perform at least one of: (i) using the dynamic steering ratio to obtain a selected hitch angle for a selected steering wheel angle for a first trailer having a first length and to obtain the selected hitch angle for the selected steering wheel angle for a second trailer having a second length; and (ii) using the dynamic steering ratio to obtain a selected hitch angle for a selected steering wheel angle when the vehicle is moving at a first velocity to obtain the selected hitch angle for the selected steering wheel angle when the vehicle is moving at a second velocity.
